(19) United States
(12) Patent Application Publication
(10) Pub. No.: US 2002/0070101 A1
(43) Pub. Date: Jun. 13, 2002

(54) Chain tensioning structure

(76) Inventors: Mark A. Hicks, Johnson City, TN (US); Marianne Hicks, Johnson City, TN (US)

Correspondence Address: Donald W. Spurrell, P.O. Box 970, Johnson City, TN, 37605, US

(21) Appl. No.: 09/732,475

(22) Filed: Dec. 7, 2000

(51) Int. Cl. B65G 23/44

(52) U.S. Cl. 198/813

(57) ABSTRACT

A tensioning mechanism for conveyor chains of the link and roller pin type wherein the mechanism has a roller shaped chain guide having a peripheral journal surface which can be forced against a loop of the chain to tension the chain, and wherein a control structure is provided for angularly positioning the chain guide about an axis to present different and desired wear portions of the journal surface to the chain roller pins.

### BACKGROUND OF THE INVENTION

1. Field

This invention concerns conveyors or other apparatus which employ chains for conveying items including products, or raw or production materials or the like, and particularly employing chains of the link and pin type, wherein a chain tensioning structure, particularly a tensioning guide is provided of unique construction and affording enhanced conveyor operation smoothness and accuracy, chain guidance and longevity of the tensioning guide and the chain itself.

2. Prior Art

Chain tensioning guides, particularly as used in conveyor systems, are typically of the plastic slide surface type, roller type, or sprocket design. See the Murfeldt, Inc., Duluth, Ga. catalog 03 A0697 541107/USA. For the former, the slide or contact surface position is substantially stationary and the chain slides over it. A spring means urges the slide surface against the chain to place it under desired tension. With the latter, the roller or sprocket is typically mounted as an idler and a spring mechanism forces the roller or sprocket against the chain to place it under proper tension.

Such chain tensioners may be positioned on the conveyor apparatus such that the contact surface thereof engages a linear section of the chain and applies an indirect tensioning force thereto. Such engagement usually generates less friction and minimizes wear on the tensioning guide slide surface, the chain itself, or the idler roller sprocket.

However, many conveyor systems, from spatial considerations or design, cannot easily accommodate such linear positioning and the tensioner contact surface must push against the chain turn with a substantially axial and direct tensioning force of substantial magnitude to attain proper tensioning. For example, conveyor systems such as shown herein employ chain rail structure which guide the chain thru curves which makes it difficult to apply a tensioning force to a linear portion of the chain. With the direct tensioning, substantially increased wear, particularly on the contact surface or on the chain results. Also, in the manufacture of conveyor systems, even where the base or framing structures are similar if not identical, it is often necessary to employ different size chains and drive means wherein the drive and tensioning sprockets or slide tensioning devices are different.

One of the principal objects of the present invention is to provide a tensioning means which has enhanced utility for a variety of chain types and sizes and which is designed for and achieves markedly greater tensioning guide wear resistance and considerably greater guide and chain longevity.

### SUMMARY OF THE INVENTION

In one preferred embodiment the present invention comprises an item conveyor apparatus utilizing at least one link and pin type continuous conveyor chain, an item supporting structure associated with the chain and adapted to allow the item to move in response to chain movement, wherein a chain tensioning structure is provided having a unique chain engaging guide in the general form of a roller rotatably mounted on a mounting structure, said roller having a peripheral contact or journal surface portion which engages the chain pin in a loop of the chain and applies tensioning force to the chain, and wherein control means is provided for regulating the angular position of the roller on the mounting structure and thus determining the contact surface portion of the roller which engages the chain pins.

In certain other preferred embodiments:

(a) the control pin means are constructed to provide a roller at each end of each link;

(b) the control means is adapted to stop the roller at any angular position on the mounting structure or to allow the roller to freely rotate thereon;

(c) the conveyor apparatus is of the magnetic slide type wherein the item is of magnetic material, wherein the supporting structure comprises a sheet metal slide positioned over and adjacent the chain, and wherein the chain is provided with magnet means which move underneath said supporting structure; and

(d) wherein said guide roller journal surface portion has a diameter less than laterally adjacent peripheral portions of the guide roller, and wherein the rollers of said chain pins have a greater diameter than the width of the chain links.

### BRIEF DESCRIPTION OF THE DRAWINGS

The invention will be further understood from the following description and drawings of certain preferred embodiments wherein:

FIG. 1 is a longitudinal cross-sectional view taken laterally of axis 12 of portions of a magnetic sliding type of conveyor on which one embodiment of the present chain tensioning guide structure is mounted;

FIG. 2 is a lateral cross-sectional view of the present tensioning structure taken along line 2-2 of FIG. 1 in the direction of the arrows without the product support means;

FIG. 3 is a lateral cross-sectional view taken along line 3-3 of FIG. 1 in the direction of the arrows;

FIG. 4 is a side view of a preferred embodiment of the present tensioning guide structure with a link and pin type chain mounted thereon and portions of the guide and chain link broken away for clarity;

FIG. 5 is a view of the peripheral surface contours of a preferred embodiment of the present tensioning guide structure with the chain shown in cross-section along line 5-5 of FIG. 4; and

FIG. 6 is a top view of the present chain tensioning structure and a segment of the product support means and chain taken generally along line 6-6 in FIG. 2 in the direction of the arrows.

### DETAILED DESCRIPTION

The present invention will be further understood from the following description of the drawings and with particular reference to the claims hereof, wherein the exemplary conveyor apparatus 10 as shown has a general longitudinal axis or plane of operation 12 and comprises base or frame means 13, rail means 14 mounted on said base means and lying substantially axially, i.e., on or parallel to plane 12 of said apparatus, continuous conveyor chain means 16 supported on said rail means for movement generally in an axial direction, chain drive sprocket means 18 engaging said chain means for driving the same generally in said axial direction, product support means 20 associated with said chain means for conveying items generally in said axial direction in response to movement of said chain means, chain tensioning means generally designated 22 comprising tensioning guide structure 24 mounted on said apparatus for angular orientation about axis 26 oriented substantially normal to said longitudinal axis, said tensioning guide structure having a circular periphery generally designated 28 formed to provide a circular, peripheral, raised journal surface 30, said chain means being mounted around and engaging said journal surface, said tensioning means further comprising tensioning force applying means 32 on said apparatus engaging said guide structure for tensioning said chain means between said drive sprocket means 18 and said journal surface, and control means such as set screws 34 and 52 on said conveyor apparatus and said guide structure for selectively controlling the angular position or motion of said guide structure about said axis 26 to thereby selectively expose different wear portions of said journal surface to said chain means.

The base means 13 is of any convenient structure and configuration for supporting any particular structure such as conveyor chain, its drive mechanism, load or workpiece or item support 20, and any desired auxiliary equipment such as feed hopper 11, take-off hopper 33, chain tensioners, transport rollers 15, electrical boxes, or the like of any size or shape.

The present invention is usefull for tensioning any of a wide variety of conveyor or other chains including those shown in the General Catalog 9/95 L10950 of Union Chain Division of U.S. TSUBAKI, INC., 301 East Marquardt Drive, Wheeling, Ill. 60090, and 1010 Edgewater Drive, Sandusky, Ohio 44870.

The chain itself may be constructed to carry any particular item, such chain being generally known in the art as carrier chains wherein platforms mount onto links of laterally spaced chains and items are placed on the platforms for transport by the moving chain. In the particular apparatus shown, the platforms 36 carry permanent magnets 35, the flux of which is transmitted thru the item support means 20 to the magnetic item such as steel bolts 37. As the chain is pulled axially along under support means 20 the item is magnetically dragged along its surface and transported, for example, thru a degreasing bath, or the like to a desired location such as hopper 33 for further processing, packaging or the like. Such magnetic conveyors, in general, are well known to the art.

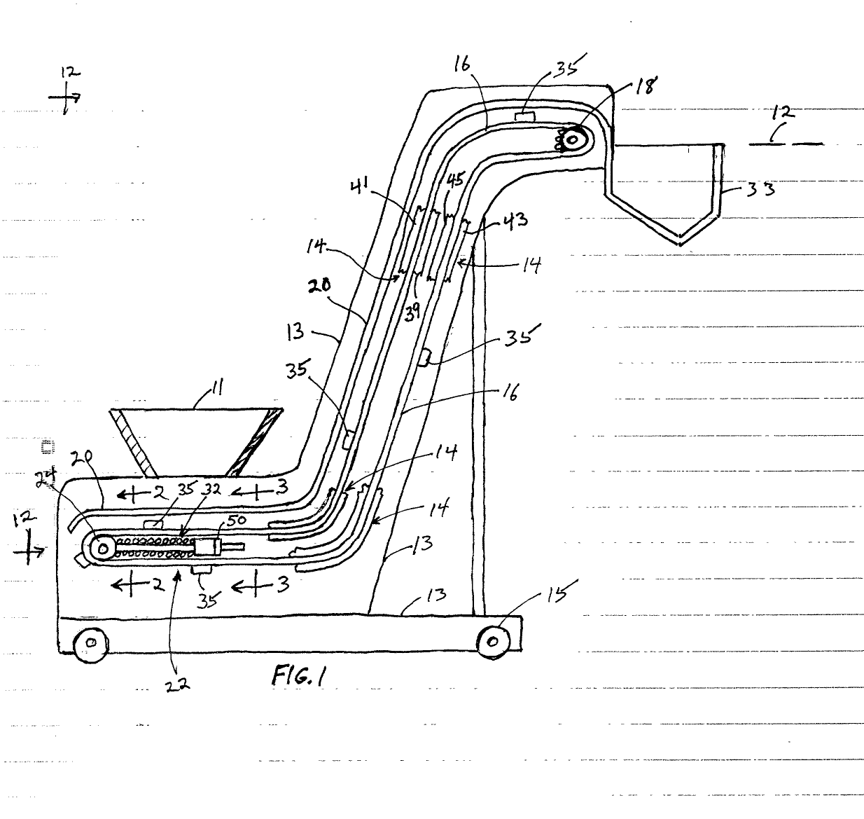

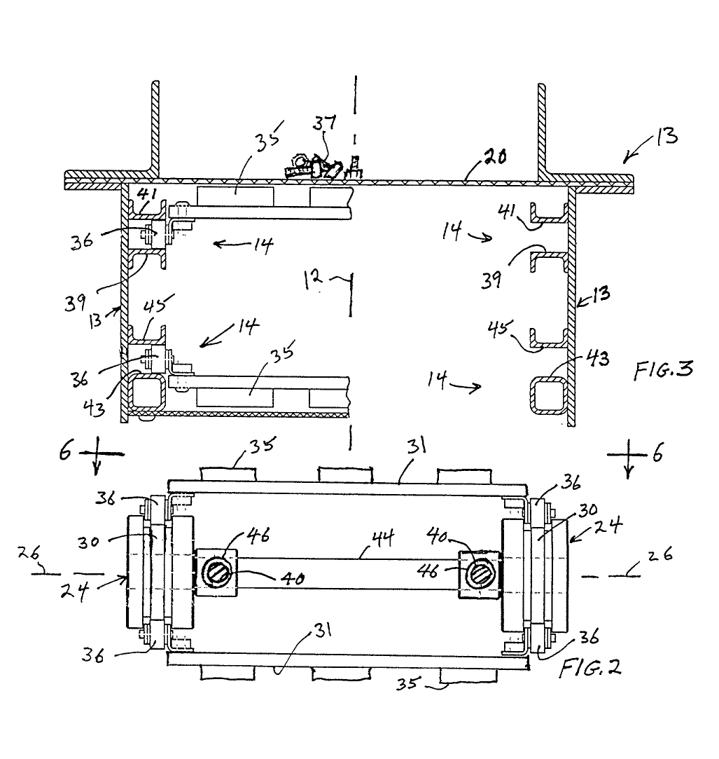

The rail means 14 is shown only as portions thereof in FIG. 1 and preferably extend substantially from adjacent sprocket means 18 to the tensioning guide 24. As shown in FIG. 3, the preferred chain is the roller type wherein the rollers 36 mounted on pins or axles 51 are guided top and bottom respectively by spaced upper sections 39, 41, and lower sections 43, 45 of the rail means 14.

The construction of the tensioning means 22 can be widely varied as its main purpose is to apply either spring force or direct pressure to the guide means 24 in a generally axial direction to maintain a desired chain tension. In the embodiment of FIG. 6 the construction of 22 is shown as comprising a stationary section or beam 38 mounted on the base 13, a pair of rods 40 slidably mounted thru 38 and welded or otherwise affixed to bushings 42 mounted on a shaft 44 having an axis 47. A compression spring 46 is mounted on each rod which are threaded at 48 for receiving an adjustment nut 50. Axial adjustment of beam 38 along supports 53 on frame 13 may be provided by means of adjustment screws 54 threaded into supports 53.

Thru the combination of the adjustment of the distance “d” by means of nuts 50, the axial adjustment of beam 38, and the selection of spring strength, essentially any desired tensioning force on the chain can be developed.

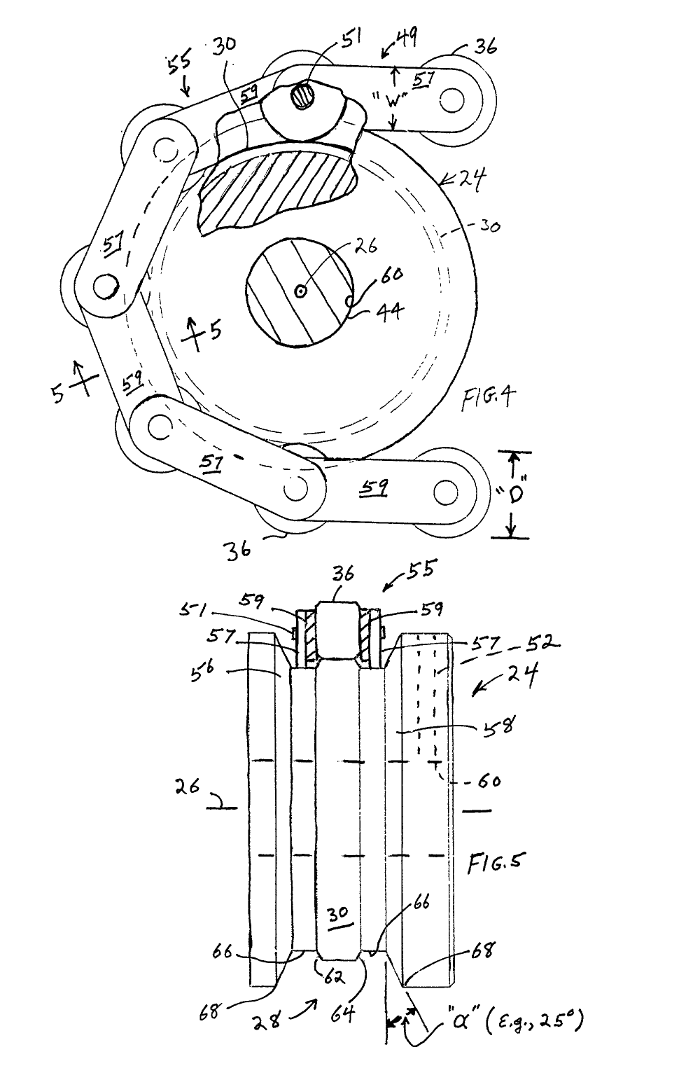

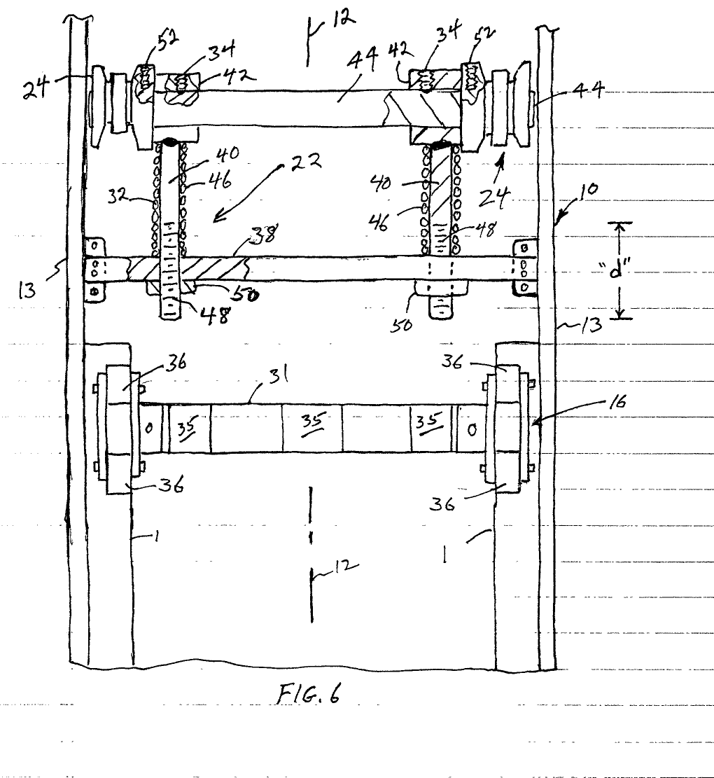

The bushings 42, in one form of the construction of 22, can be non-rotatably fixed to shaft 44 by set screws or the like 34, and wherein the guide means or roller 24 are rotatably mounted on shaft 44 but can be fixed in any desired angular position thereon by means of a set screw or the like 52 threaded thru the guide means and bearing against 44. The guide means 24 in another embodiment can be allowed to rotate freely on shaft 44 by removing set screws 52. In another construction variation of 22, the guide means 24 can be fixed to shaft 44 and the shaft allowed to rotate in bushings 42. Referring to FIGS. 4 and 5 the configuration and dimensions of the guide means 24 are designed to give the best performance with the type of link segment generally designated 49 and 55, wherein the link sides 57 and 59 respectively have a width “W”, and pin means comprising pin 51 and rollers 36 of diameter “D”.

With particular reference to the guide roller, per se, that aspect of the present invention is generally defined as a guide roller 24 for use with a tensioning device 22 for a continuous conveyor chain 16 having alternating link segments 49 and 55 and pin means 51, 36, each alternating link segment having a pair of sides 57 and 59 respectively, said roller having a shaft bore 60 providing an axis of rotation 26, said roller having a first pair of axially spaced and generally radially directed shoulder means 56, 58 on its periphery, and further having a radially elevated ridge providing a circular journal surface 30 on its periphery lying between said shoulder means and adapted to engage the pin means of a chain, said ridge being formed by a second pair of generally radially directed shoulder means 62, 64, said first pair of shoulder means being adapted to engage outer side portions of the chain link sides 57, and said second pair of shoulder means being adapted to engage inner side portions of the chain link sides 59 and thereby maintain contact of the journal surface 30 with the pin means. It is preferred that each shoulder means 56 and 58 is beveled outwardly from root surface 66 to periphery 68 thereof at an angle “α” of from about 20° to about 30°, and most preferably about 25°. It is also preferred that shoulder means 62 and 64 be beveled inwardly from 66 to an angle of from about 40° to about 50°, and most preferably about 45°.

The invention has been described in detail with particular reference to preferred embodiments thereof, but it will be understood that variations and modifications will be effected with the spirit and scope of the invention.

I claim:

1. A conveyor apparatus for a variety of items having a longitudinal axis or plane of operation and comprising base means, rail means mounted on said base means and lying substantially axially of said apparatus, continuous conveyor chain means supported on said rail means for movement generally in an axial direction, chain drive sprocket means engaging said chain means for driving the same generally in said axial direction, item support means associated with said chain means for supporting items as they are being conveyed generally in said axial direction in response to movement of said chain means, chain tensioning means comprising tensioning guide means mounted on said apparatus for angular or positioning about an axis oriented substantially normal to said longitudinal axis, said tensioning guide means having a circular periphery formed to provide a circular, peripheral, raised journal surface, said chain means being mounted around and engaging said journal surface, said tensioning means further comprising force applying means on said apparatus engaging said guide means for tensioning said chain means between said sprocket means and said journal surface, and control means on said guide means for selectively controlling the angular position of said guide means about said axis to selectively expose different wear portions of said journal surface to said chain means.

2. The apparatus of claim 1 wherein said chain means is of the link and pin type and wherein annular raised shoulder means are provided on said circular periphery to each side of said journal surface and adapted for contacting side portions of said chain links and maintaining the pin means of said chain means in contact and alignment with said journal surface.

3. The apparatus of claim 2 wherein said pin means comprises a chain roller and axle wherein the rollers roll on said journal surface.

4. The apparatus of claim 1 wherein said item contains ferrous magnetic material, wherein said chain means is provided with magnet means, and wherein said support means comprises a stationary slide surface adapted to lie adjacent the moving magnet means, whereby movement of said chain means and magnet means causes sliding of said item along said slide surface.

5. The apparatus of claim 3 wherein each said shoulder means is beveled axially outwardly from root to periphery thereof at an angle “α” of from about 20° to about 30°.

6. The apparatus of claim 1 wherein said guide means is affixed to shaft means which is mounted for rotation in bearing means, and wherein said control means comprises position locking means provided on said shaft means and bearing means, and wherein said tensioning means comprises spring means having one portion engaging a stationary portion of said apparatus and having another portion engaging said bearing means for exerting tensioning force on said chain means.

7. The apparatus of claim 1 wherein said chain means comprises a pair of laterally spaced roller chains wherein chain roller peripheries extend above and below the link sides of said chains.

8. The apparatus of claim 1 wherein said guide means is rotatably mounted on shaft means which is non-rotatably fixed to said tensioning means, wherein said control means comprises position locking means provided on said guide means and shaft means, and wherein said tensioning means comprises spring means having one portion engaging a stationary portion of said apparatus and having another portion engaging said shaft means for exerting tensioning force on said chain means.

9. A conveyor utilizing at least one continuous conveyor chain comprised of link means and pin means, an item supporting structure associated with said chain and adapted to allow the item to move in response to chain movement, wherein a chain tensioning structure is provided having a tensioning force generating means and a chain engaging guide roller rotatably mounted on a mounting structure on an axis of rotation, said mounting structure being associated with said tensioning force generating means, said roller having peripheral journal surface portions which engage the chain pin means within a loop of the chain and apply tensioning force to the chain, and wherein control means is provided on said conveyor for regulating the angular position of said guide roller about said axis and thus determining the journal surface portions of the guide roller which engage the chain pin means.

10. The conveyor of claim 9 wherein each said chain pin means comprises an axle and a roller rotatably mounted thereon for rollably engaging said Journal surface portions.

11. A guide roller tilt for use with a tensioning device for a continuous conveyor chain having alternating narrow and wide link segments comprising link side sections and pin means for pivotally connecting said section and segments, said roller having a shaft bore providing an axis of rotation, said roller further having a pair of first axially spaced and generally radially directed shoulder means on its periphery, and further having a radially elevated ridge providing a circular journal surface on its periphery lying between said shoulder means and adapted to engage the pin means of a chain, said ridge being formed by a pair of second generally radially directed shoulder means, said first shoulder means being adapted to engage outer side portions of the wide link segments, and said second shoulder means being adapted to engage inner side portions of the narrow link sides and thereby maintain contact of the journal surface with the pin means.

12. The roller of claim 11 having an element of a control means which is adapted to cooperate with another element of the control means on a conveyor for regulating the angular position of said guide roller about said axis and thus determining the journal surface portions of the guide roller which engage the chain pin means.

13. The roller of claim 11 wherein each said first shoulder means is beveled outwardly from root surface to periphery thereof at an angle “α” of from about 20° to about 30°.

14. The roller of claim 13 wherein each said second shoulder means is beveled inwardly from root surface to periphery thereof at an angle of from about 40° to about 50°.
